(19) United States
(12) Patent Application Publication
(10) Pub. No.: US 2017/0023674 A1
(43) Pub. Date: Jan. 26, 2017

(54) VEHICULAR RADAR ADJUSTMENT MECHANISM

(71) Applicant: Ford Global Technologies, LLC, Dearborn, MI (US)

(72) Inventors: Muhammad Azhar ALEEM, Canton, MI (US); Fred GAYNIER, Livonia, MI (US); Brian FATH, Farmington Hills, MI (US); David James LAWOR, Bloomfield Hills, MI (US)

(21) Appl. No.: 14/803,222

(22) Filed: Jul. 20, 2015

(51) Int. Cl. G01S 13/93; G01S 7/02; G01S 13/04

(52) U.S. Cl. CPC G01S 13/931; G01S 13/04; G01S 7/02; G01S 2007/027; G01S 2013/9389

(57) ABSTRACT

A vehicle is provided with a forward-looking radar (FLR) assembly. The assembly includes a radar module mounted to a bracket or frame of the vehicle. Because precision in the angular positioning of the radar is desirable, the radar module is designed such that its vertical angular orientation can be adjustable. An adjustment screw connects the radar module and the bracket. The adjustment screw is provided with a plurality of annular flat engagement surfaces between the radar module and the bracket. Rotation of the engagement surfaces rotates the adjustment screw, causing the radar module to angularly adjust relative to the bracket. The engagement surfaces being between the radar module and the bracket allow for adjustment of the adjustment screw from its side in addition to its end surfaces.

### TECHNICAL FIELD

The present disclosure relates to a mechanism for adjusting a radar unit in a vehicle.

### BACKGROUND

Active safety systems for vehicles have been growing in popularity in recent years. These systems typically sense a vehicle's external environment, determine a safety criticality level of current and near future events based on the sensed data, and actuate on-board vehicle systems to react accordingly. In many of these active safety systems, the vehicle's external environment is sensed using a forward looking radar (FLR) unit.

Due to limitations set by the Federal Communications Commission (FCC) and other governing bodies, a radar may be limited to a maximum threshold energy level or frequency. Given these limitations, the beam emitted from the FLR unit must be relatively tight to maximize the range of the beam so that the FLR unit can sense at adequate distances from the vehicle. Therefore, the FLR unit, and hence the radar beam, is typically aligned with a relatively high degree of angular accuracy, such as vertical angular accuracy.

A high degree of accuracy in the angular positioning of the FLR unit is therefore preferable. FLR units are typically packaged near the front bumper of the vehicle, and accessing the FLR unit for angular adjustment can be difficult due to the structure around the FLR unit.

### SUMMARY

According to one embodiment, a vehicle radar assembly comprises a radar module, a bracket, and a fastener. The radar module has a flange. The fastener secures and spaces apart the flange and the bracket. The fastener includes a threaded shaft threadedly engaged with one of the flange and bracket, and a nut fixed with the shaft between the flange and bracket such that rotation of the nut adjusts a position of the radar module along an axis of the fastener relative to the bracket.

According to another embodiment, a vehicle radar assembly is provided. A radar module is mounted to the vehicle and defines a first aperture. A bracket is spaced from the radar module and defines a second threaded aperture. A fastener has a threaded portion threadedly engaged with the second threaded aperture, a non-threaded portion extending through the first aperture, and a nut fixed with the portions and disposed between the first and second threaded apertures.

According to yet another embodiment, a vehicle comprises a radar module, and a bracket secured to the radar module and mounted to a front bumper beam. An adjustment screw connects the radar module and the bracket. The adjustment screw defines a nut disposed between the radar module and bracket, and is configured such that rotation of the nut adjusts a position of the radar module relative to the bracket along an axis of the adjustment screw.

### BRIEF DESCRIPTION OF THE DRAWINGS

FIG. 1 is a perspective view of a vehicle including a forward looking radar (FLR) unit mounted onto the vehicle;

FIG. 2 is a front perspective view of the FLR unit mounted to the vehicle;

FIG. 3 is a rear perspective view of the FLR unit mounted to the vehicle;

FIG. 4 is a side perspective view of an adjustment mechanism for adjusting the angular position of the FLR unit relative to the vehicle; and

FIG. 5 is a side perspective view of an adjustment mechanism for adjusting the angular position of the FLR unit relative to the vehicle.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

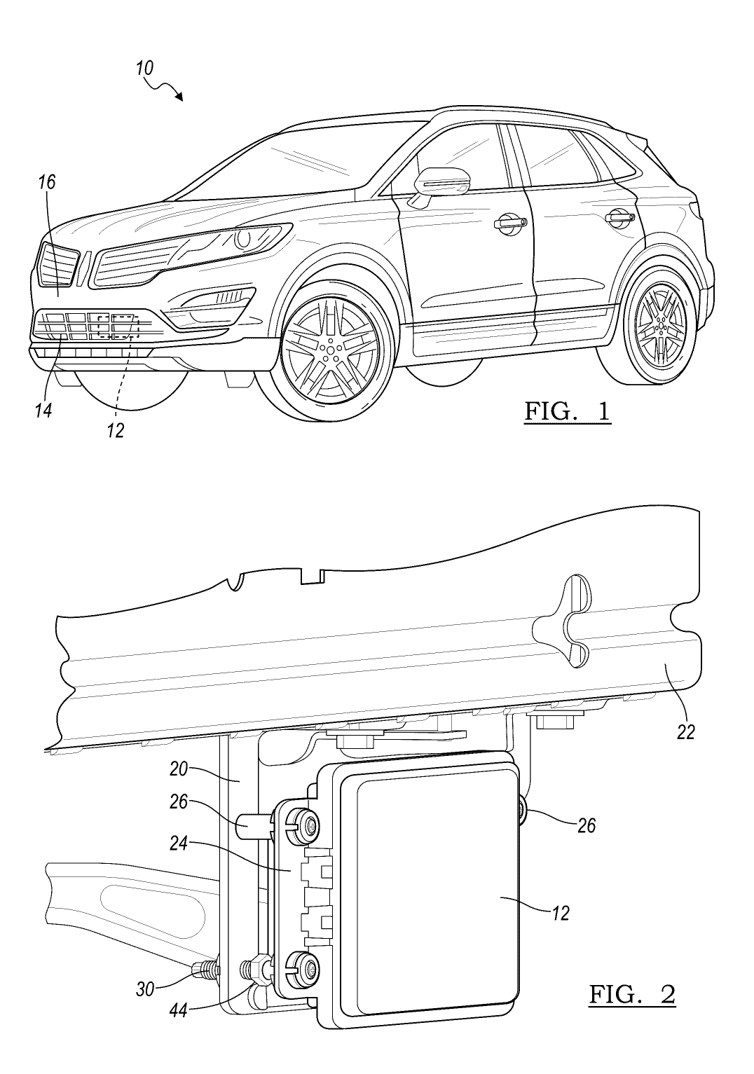

Turning to the drawings, FIG. 1 illustrates a perspective view of a vehicle 10 including a forward looking radar (FLR) unit 12 mounted to the vehicle 10 behind a front grille 14 and below a bumper fascia 16. Of course, the location and size of the FLR unit 12 relative to the front grille 14 and bumper fascia 16 may vary among assemblies to suit various packaging concerns. The FLR unit 12 may also be behind or integral with the bumper fascia 16. As will be described below, in at least one embodiment, the FLR unit 12 is mounted to a mounting bracket, which is mounted to the front bumper and rail of an apron assembly. It should be understood that the specific arrangement of the FLR unit 12 illustrated in FIG. 1 is merely exemplary. The FLR unit 12 can be a module or housing that surrounds a radar transmitting device.

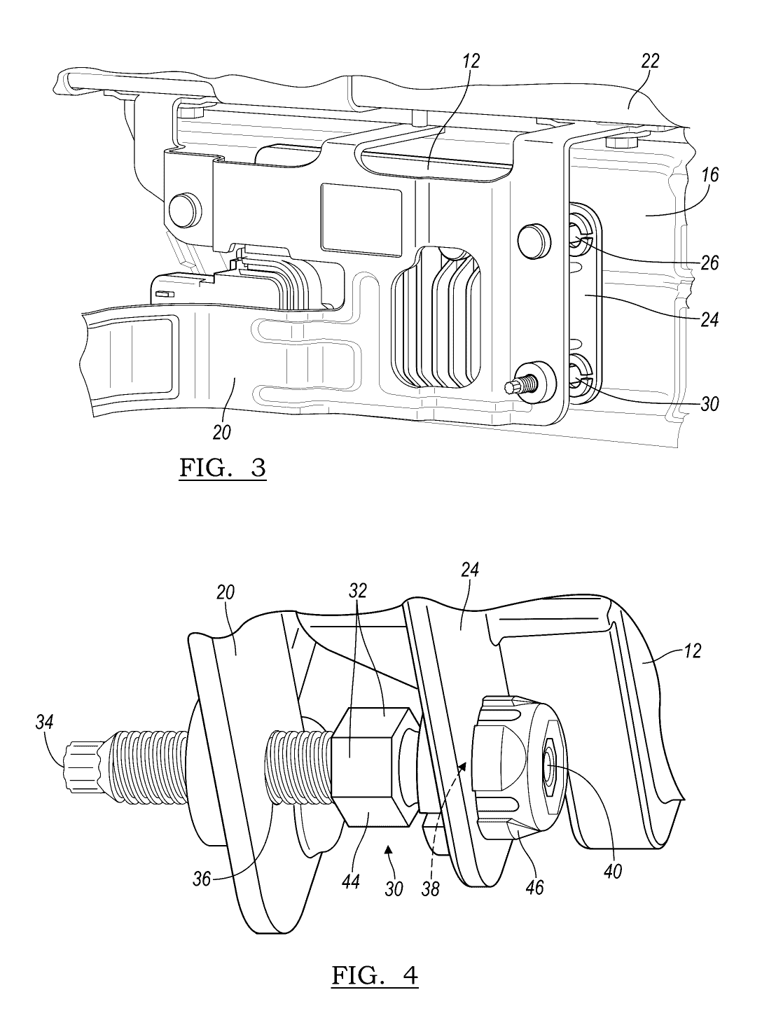

FIG. 2 illustrates a front perspective view of the FLR unit 12 mounted to a bracket 20 with the front bumper fascia 16 removed for illustrative purposes. FIG. 3 provides a rear perspective view of the FLR unit 12 mounted to the bracket 20, with the grille region of the front bumper fascia 16 shown in front of the FLR unit 12. The bracket 20 mounts the FLR unit 12 to a rail or front bumper 22.

As shown in FIGS. 2 and 3, the FLR unit 12 includes a flange 24 on either side to provide a mounting surface. The flanges extend away from the center of the FLR unit 12 and toward either side of the vehicle. The bracket 20 includes a corresponding attachment surface aligned with the flanges 24. A fastener 26 mounts the flange of the FLR unit 12 to the attachment surface of the bracket 20. The fastener 26 may be a fixed spacer or the like that is not designed to adjust the distance between the bracket 20 and the FLR unit 12. In other words, the fastener 26 affixes the flange 24 to the bracket 20 in a spaced-apart relationship to maintain a fixed distance between the flange 24 and the bracket 20 along the fastener.

A fastener such as an adjustment screw 30 is also provided. Each flange 24 can be provided with one or more adjustment screws 30. The adjustment screw 30 acts as an adjustment mechanism to allow a user to rotate the adjustment screw 30 to modify the distance between the FLR unit 12 and the bracket 20 at the location of the adjustment screw 30. This provides the user with the ability to finely-tune the angular positioning of the FLR unit 12 with respect to the bracket 20. When the adjustment screw is rotated, the FLR unit 12 can move toward and away from the bracket along the axis of the adjustment screw 30. The spacing between the FLR unit 12 and the bracket 20 can be therefore be altered by rotating the adjustment screw. Since the fastener 26 maintains a fixed distance between the FLR unit 12 and the bracket 20 at the location of the fastener 26, rotation of the adjustment screw 30 causes the FLR unit 12 to slightly pivot about the fastener 26.

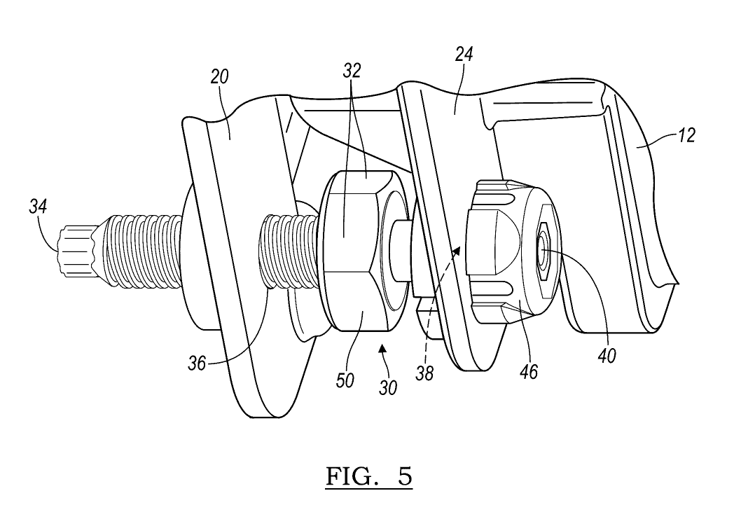

As best illustrated in FIG. 3, the packaging of the FLR unit 12 can cause difficulty in accessing the adjustment screws 30. For example, once the FLR unit 12 is installed in the vehicle and needs to be adjusted, it can be difficult to reach the adjustment screw in the axial direction due to the fascia 16, the bracket 20, the bumper 22, and powertrain components behind the bracket 20 (not shown). The adjustment screws 30 are therefore provided with rotatable, flat engagement surfaces 32 between the bracket 20 and the flange 24 of the FLR unit 12. These engagement surfaces 32 can be part of a nut, for example. Additional illustration of the engagement surfaces 32 of the adjustment screw 30 is shown in FIGS. 4 and 5.

Vertical angular adjustment is thus provided by the use of an adjustment screw 30 with engagement surfaces (e.g., a nut) between the FLR unit 12 and the bracket 20. In a preferred embodiment, one adjustment screw 30 is provided at the bottom of the FLR unit 12, and a corresponding fixed fastener 26 is provided above the adjustment screws 30. Of course, more than one adjustment screw and corresponding fastener can be provided. In another embodiment, the adjustment screws 30 and the fixed fasteners 26 have their location swapped such that the adjustment screws 30 are above the fasteners 26.

FIG. 4 shows a perspective view of the adjustment screw 30 with a plurality of flat engagement surfaces 32 between the bracket 20 and the flange 24 of the FLR unit 12. The adjustment screw 30 extends from a first end 34, through an aperture or hole 36 in the bracket 20, through an aperture or hole 38 in the flange 24, and to a second end 40. Thus, the adjustment screw secures the FLR unit 12 to the bracket 20 while extending through both holes 36, 38 that are aligned with one another. A nut 44 is machined into the adjustment screw 30 such that the nut 44 and the adjustment screw 30 are one unitary, singularly-formed unit. The nut 44 includes a plurality of engagement surfaces 32 that are radially-outward of the shaft of the adjustment screw 30. The engagement surfaces 32 allow a user to access the adjustment screw 30 from a position offset from the axis of the adjustment screw 30. In other words, the engagement surfaces 32 allow a tool to access the adjustment screw 30 from the side of the adjustment screw 30, rather than at one of the ends 34, 40 of the adjustment screw, in order to adjust the angular position of the FLR unit 12. Gaps are provided on either side of the nut 44 allow the adjustment screw 30 to travel an intended length when adjusting the angle of the FLR unit 12; a gap exists between the nut 44 and the bracket 20, and between the nut 44 and the flange 24.

A grommet 46 is provided in the hole 38 of the flange 24. The grommet 46 is fixed within the hole 38 and receives the adjustment screw 30. The grommet 46 includes an interior cavity having an interior surface to engage the external surface of the adjustment screw 30 near its second end 40. In one embodiment, the adjustment screw 30 includes a ball head at or near the second end 40 that snaps into the grommet 46 which allows the grommet 46 to absorb a small amount of rotation due to the tilting of the FLR unit 12. In this embodiment, the adjustment screw does not spin freely within the grommet 46. In other embodiments, the adjustment screw 30 is able to spin freely within the grommet 46 as the engagement surfaces 32 are rotated. The second end 40 of the adjustment screw 30 pushes against the interior surface of the grommet 46 as the screw 30 is rotated, causing the flange 24 to move toward and away from the bracket 20 for adjustment.

The adjustment screw 30 can also be provided with an axial feature at its first end 34 for adjustment. The axial feature can be star-shaped, as best shown in FIG. 3.

FIG. 5 is similar to FIG. 4, except that the adjustment screw 30 is provided with a hex nut 50 that is welded thereon. The hex nut 50 can be welded at a predefined location with sufficient gaps on either side to allow the adjustment screw 30 to be rotated and extended the appropriate distance during adjustment.

References herein to the forward looking radar (FLR) unit are not necessarily limited to only radar units at the front of the vehicle. The adjustment mechanisms can be incorporated to the radar units in various positions about the vehicle. As vehicles become more autonomous, the number, size, and location of radar units vary. The teachings provided above regarding adjustment mechanisms for adjusting the FLR unit can be implemented to different radar units about the vehicle, as one of ordinary skill in the art will understand.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A vehicle radar assembly comprising:
a radar module having a flange;
a bracket; and
a fastener securing and spacing apart the flange and bracket, the fastener including a threaded shaft threadedly engaged with one of the flange and bracket, and a nut fixed with the shaft between the flange and bracket such that rotation of the nut adjusts a position of the radar module along an axis of the fastener relative to the bracket.

2. The assembly of claim 1, wherein the nut defines a plurality of generally planar engagement surfaces.

3. The assembly of claim 1, wherein the nut is connected to the fastener via a weld connection.

4. The assembly of claim 1, wherein the nut and shaft are a single unitary machined piece.

5. The assembly of claim 1, further comprising a second fastener affixing the flange to the bracket in a fixed spaced-apart relationship to maintain a fixed distance between the flange and the bracket along an axis of the second fastener during rotation of the nut.

6. A vehicle radar assembly comprising:
a radar module mounted to the vehicle and defining a non-threaded aperture;
a bracket spaced from the radar module and defining a threaded aperture; and
a fastener having a threaded portion threadedly engaged with the threaded aperture, a non-threaded portion extending through the non-threaded aperture, and a nut fixed with the portions and disposed between the first and second threaded apertures.

7. The vehicle radar adjustment assembly of claim 6, wherein the nut includes a plurality of engagement surfaces outboard of the threaded portion.

8. The vehicle radar adjustment assembly of claim 6, wherein the nut is connected to the fastener via a weld connection.

9. The vehicle radar adjustment assembly of claim 6, wherein the nut and the portions are a single unitary machined piece.

10. The vehicle radar adjustment assembly of claim 6, further comprising a grommet received within the first aperture and including an interior surface for engaging the non-threaded portion.

11. The vehicle radar adjustment assembly of claim 6, further comprising a second fastener mounting the bracket to the radar module in a fixed spaced relationship, wherein the radar module defines a third aperture, wherein the bracket defines a fourth aperture aligned with the third aperture, and wherein the second fastener extends through the third and fourth apertures.

12. A vehicle comprising:
a radar module;
a bracket secured to the radar module and mounted to a front bumper beam; and
an adjustment screw connecting the radar module and the bracket, the adjustment screw defining a nut disposed between the radar module and bracket, and configured such that rotation of the nut adjusts a position of the radar module relative to the bracket along an axis of the adjustment screw.

13. The vehicle of claim 12, wherein the adjustment screw includes a threaded portion threadedly engaged with the bracket and a non-threaded portion extending through the radar module.

14. The vehicle of claim 13, wherein the nut is welded with the portions.

15. The vehicle of claim 13, wherein the nut and portions are a single unitary machined piece.

16. The vehicle of claim 13, further comprising a grommet extending through a hole defined by the radar module and defining an interior surface configured to engage the non-threaded portion.

17. The vehicle of claim 12, further comprising a fastener connecting the bracket to the radar module in a fixed spaced relationship at a location vertically spaced from the adjustment screw such that rotation of the nut pivots the radar module about the fastener.
